(19) United States
(12) Patent Application Publication
(10) Pub. No.: US 2005/0018835 A1
(43) Pub. Date: Jan. 27, 2005

(54) Device for automatically opening a customer loop in a telecommunication network

(76) Inventor: Didier Neveux, Cavan (FR)

Correspondence Address: Blakely Sokoloff Taylor & Zafman, Seventh Floor, 12400 Wilshire Boulevard, Los Angeles, CA, 90025, US

(21) Appl. No.: 10/276,477

(22) PCT Filed: May 16, 2001
(86) PCT No.: PCT/FR01/01489

(30) Foreign Application Priority Data
May 16, 2000 (FR) 00 06197

(51) Int. Cl. H04M 1/00; H04M 3/00; H04M 9/00

(52) U.S. Cl. 379/377; 379/387.01

(57) ABSTRACT

The present invention provides a system associated with a terminal (30) of a telecommunications line (10), the system being characterized by the fact that it comprises: at least one detector of local and behavioral parameters intrinsic to the use of the terminal concerned;
an analyzer device (60) for analyzing pertinent parameters to determine that an off-hook state of the line (10) is inappropriate on the basis of the signal from the sensor (50); and
a control device (70) for controlling line seizing and suitable for causing the telecommunications line (10) to be deactivated in the on-hook position when said analyzer device (60) determines that the off-hook state of the line (10) is inappropriate.

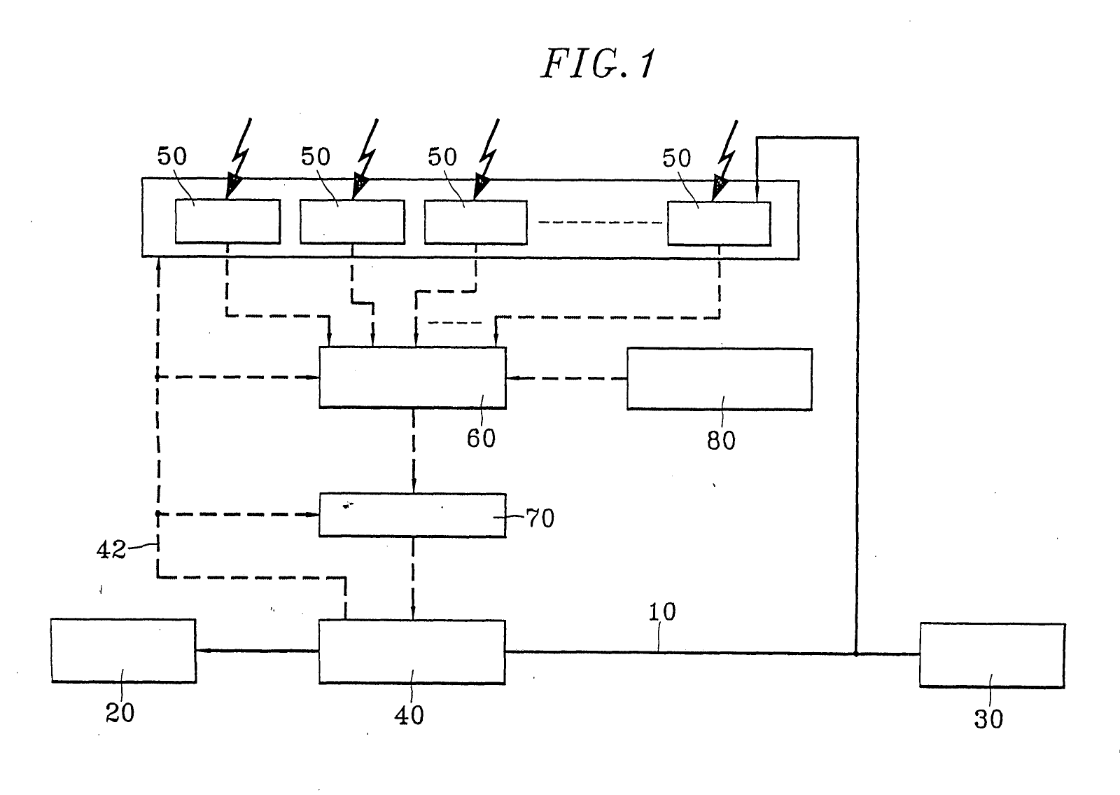

The present invention relates to the technical field of terminals for telecommunications networks.

It applies to all types of network, whether they carry voice, video, or data.

A general object of the present invention is to provide a device enabling a terminal to be placed automatically in a call-waiting situation whenever the user of the terminal forgets to terminate a call, or does so in a manner that is incorrect or incomplete.

Such a situation can arise in numerous circumstances, in particular if the telephone handset is hung up wrongly, if the user forgets to hang up the handset at the end of a call (or forgets to actuate a button on a mobile telephone or on a cordless telephone, etc. . . . ), or if the handset is picked up in untimely manner (clumsy handling, children playing, etc. . . . ).

The problem as posed in this way is well known to the person skilled in the art.

Solutions for causing or simulating an “automatic hang-up” have already been proposed for Minitel services, in certain Minitel emulations for personal computers (PCs), and in Internet connection kits.

Numerous documents, in particular patents, have also been published concerning automatic hang-up techniques for faxes.

Nevertheless, so far as the inventor is aware, at present, in the field of telephone services, no satisfactory system has yet been proposed.

Document U.S. Pat. No. 5,923,748 attempts to propose a solution to the above-explained problem. However the technique proposed therein relies on the terminal detecting a signal sent by its parent exchange or switch, and it does not appear to present sufficient reliability, remaining too dependent on the parent switch, and it does not appear to be accepted by the interested parties.

Document DE-1 964 4841 does no more than recommend generating an alarm signal.

The Document Patent Abstracts of Japan, Vol. 1999, No. 13 does no more than recommend special sensors on the sides of a portable handset.

Document U.S. Pat. No. 5,606,593 proposes using a timer.

Thus, at present, in the event of a terminal not being properly “on-hook” ready to receive an outside call, it is not possible for an outside party to make contact with the user of the terminal that is “off-hook”. The operator thus loses calls and uses resources to deliver a tone indicating that the line of the client whose terminal is off-hook is not available.

In the light of that prior art, the object of the invention is to provide better accessibility to the users of terminals.

In the context of the present invention, this object is achieved by a system which comprises:
at least one detector of local and behavioral parameters intrinsic to the use of the terminal concerned, e.g. a movement detector, a temperature detector, a light detector, a sound level detector, a pressure detector, etc. . . . ;
an analysis system for analyzing pertinent parameters to judge whether the “off-hook” state of the line is inappropriate on the basis of signals coming from the sensor; and
a control system for controlling line seizing, suitable for causing the telecommunications line to be deactivated into the “on-hook” position when said analysis system determines that the off-hook state of the line is inappropriate.

The system of the present invention thus makes it possible to interrupt an unwanted connection after analyzing pertinent local signals, and consequently to release the telephone line and make the terminal available for a distant caller.

According to an advantageous characteristic of the present invention, the device further comprises a member for deactivating the system for causing the line to be seized under the control of the parameter analysis system.

Other characteristics, objects, and advantages of the present invention appear on reading the following detailed description made with reference to the accompanying drawing given by way of non-limiting example and showing a device in accordance with the present invention in the form of a block diagram.

In the accompanying figure, reference 10 designates a line connecting a telecommunications network 20 to a terminal 30 such as a telephone set.

It should be observed that a line seizing circuit 40 is present on the above-mentioned line 10 between the network 20 and the terminal 30.

As can be seen in the accompanying figure, the device of the present invention comprises at least one detector 50 of local and behavioral parameters intrinsic to the use of the terminal 30 (preferably a plurality of such sensors 50), an analyzer device 60 for analyzing signals coming from the sensor(s) 50, and a control device 70 controlled by the analyzer device 60 and adapted to control the line seizing circuit 40.

Preferably, as described in detail below, the device of the present invention further comprises an over-ride member 80 for deactivating the automatic hang-up function implemented in this way.

In the accompanying figure, not all of the functions of the terminal 30 are shown. For example and in non-limiting manner, its ringing, keypad, . . . functions are not shown in the accompanying figure in order to simplify the drawing.

As mentioned above, the principle of the invention relies on analyzing pertinent local parameters associated with the use of the terminal 30, e.g. a telephone terminal.

This analysis can be performed continuously. In a variant, it can be initiated by the line seizing circuit 40 during the operation which corresponds to taking the handset or terminal 30 off-hook.

For this purpose, for example as shown in the accompanying figure, the line seizing circuit 40, on detecting that the terminal 30 has gone off-hook, can activate the means corresponding to the sensors 50, the analyzer device 60, and the control device 70 by means of a line referenced 42 in the figure.

In the context of the present invention, the “off-hook” function for the line 10 can be operated in various ways such as literally picking up the handset or terminal 30, pressing on a key, issuing a voice command.

Similarly, the line seizing circuit 40 can itself be implemented in a wide variety of ways.

The pertinent parameters monitored by the detectors 50 can be varied.

In the context of the present invention, particular, but non-limiting mention is made of the following:
movement; lack of movement of the terminal 30 can indicate that the handset is no longer held in the hand;
temperature; the corresponding sensor 50 detects the human warmth of the user, this can come from the hand which is holding the handset, from the ear, from air that is breathed out . . . ;
light; the hand holding the handset, the ear pressed against the handset 30, can obstruct a light detector;
sound level; when the level from the microphone is too low, it indicates that there is no speech; and
pressure; the hand holding the handset 30 can exert pressure, as can the ear pressed against the handset 30.

When the analyzer device 60 responds to analyzing the signals from the sensor 50 or the sensors 50, by detecting a pertinent parameter representative of the off-hook state of the line 10 being inappropriate, it activates the control device 70 to cause the line 10 to be deactivated, i.e. for it to take up the “on-hook” position, with this being done by the line seizing circuit 40.

The analyzer device 60 preferably makes use of a timer. I.e. it is preferable for the analyzer device 60 to enable an order to deactivate the line as issued by the control device 70 only if the presence of the pertinent parameter indicating that an off-hook state is inappropriate persists for a predetermined duration.

To this end, and by way of example, a time counter is triggered in the analyzer device 60 at the beginning of detection of a pertinent parameter. The counter is reinitialized and stopped in the event of a change in the state of said parameter being detected before the time limit. Otherwise, a line-deactivating order is issued by the analyzer device 60 if the predetermined time limit is reached without the counter being reset to zero.

The order for deactivating the line can be issued after taking account of a single parameter.

However, in the context of the invention, the analyzer device 60 may also take account of a plurality of parameters coming from respective sensors 50, by using logic AND functions (in which case the order to deactivate the line 10 is given only if a plurality of different parameters are detected) or an OR function (in which case the order to deactivate the line 10 is given as soon as one or more detected parameters comply with the OR function given in this way). The analyzer device 60 can also combine such logic AND and OR functions.

The analyzer device 60 can also apply weighting factors to the parameters monitored by the various sensors 50 depending on the significance given to this or that parameter, prior to allowing the line seizing circuit 40 to be ordered to deactivate the line 10.

Naturally, in a variant, the timing and the logic and weighting functions mentioned above can be performed equally well in the analyzer device 60 or in the control device 70 for controlling the line seizing circuit 40.

In yet another variant, and simultaneously with ordering the line seizing circuit 40 to deactivate the line, i.e. to perform the same function as putting the phone back on-hook, the device of the invention may also order deactivation of one or more of the essential functions of the device, or it may order information to be exchanged between the functional blocks, as selected by the user setting up the device. For example, for this purpose, it is possible to envisage switching off the electrical power supply to the elements constituting the invention.

As mentioned above, it is also preferable for the device to include an over-ride module 80 suitable for enabling the user to deactivate the automatic hang-up function formed by the invention, by inhibiting one or more of the essential functions of the device or the exchanges of information between the functional blocks that it forms.

Such an over-ride module 80 can be constituted by a keypad, a voice command, or any functionally equivalent system.

The accompanying figure shows the case where the automatic hang-up function is inhibited by sending an order to the analyzer device 60. This inhibition is preferably capable of being activated during a call and while not involved in a call.

In addition, and preferably, an indicator, e.g. an indicator light, is provided to show the state of the over-ride member 80 and thus warn the user that the automatic hang-up function is deactivated.

Naturally, the present invention is not limited to the particular embodiments described above but extends to any variant in the spirit of the invention.

It should be observed that the device of the present invention can be applied equally well to a fixed telephone service as to a mobile telephone service.

Furthermore, the basic functions of the invention can be physically centralized or they can be distributed, for example being located in a handset and/or in a telephone terminal base.

1/ A system associated with a terminal (30) of a telecommunications line (10), the system being characterized by the fact that it comprises:
at least one detector of local and behavioral parameters intrinsic to the use of the terminal concerned;
an analyzer device (60) for analyzing pertinent parameters to determine that an off-hook state of the line (10) is inappropriate on the basis of the signal from the sensor (50); and
a control device (70) for controlling line seizing and suitable for causing the telecommunications line (10) to be deactivated in the on-hook position when said analyzer device (60) determines that the off-hook state of the line (10) is inappropriate.

2/ A system according to claim 1, characterized by the fact that it. comprises at least one detector (50) selected from the group comprising: a movement detector; a temperature detector; a light detector; a sound level detector; and a pressure detector.

3/ A system according to claim 1 or claim 2, characterized by the fact that it further comprises an over-ride module (80) for deactivating the automatic hang-up function.

4/ A system according to claim 3, characterized by the fact that it includes an indicator for indicating the state of the over-ride module (80).

5/ A system according to any one of claims 1 to 4, characterized by the fact that the analyzer device (60) makes use of a timer on detecting pertinent local and behavioral parameters.

6/ A system according to any one of claims 1 to 5, characterized by the fact that the analyzer device (60) implements a cumulative logic function of the AND type on at least two pertinent local and behavioral parameters.

7/ A system according to any one of claims 1 to 6, characterized by the fact that the analyzer device (60) implements an alternative logic function of the OR type on a plurality of pertinent local and behavioral parameters.

8/ A system according to any one of claims 1 to 7, characterized by the fact that it implements weighting factors on the local and behavioral parameters that are involved.

9/ A system according to any one of claims 1 to 8, characterized by the fact that it includes means for deactivating at least one of the essential functions of the device or the exchanges of information between its functional blocks.
